(19) United States
(12) Patent Application Publication
(10) Pub. No.: US 2020/0115955 A1
(43) Pub. Date: Apr. 16, 2020

(54) SYSTEM AND DEVICES FOR PREVENTING WATER INFILTRATION

(71) Applicant: Norman Dennis Eryou, Naples, FL (US)

(72) Inventor: Norman Dennis Eryou, Naples, FL (US)

(21) Appl. No.: 16/444,516

(22) Filed: Jun. 18, 2019

Related U.S. Application Data
(60) Provisional application No. 62/745,698, filed on Oct. 15, 2018.

(51) Int. Cl. E06B 7/26; E06B 7/23; E06B 1/70; E04B 1/68; E06B 1/62

(52) U.S. Cl. CPC E06B 7/26; E06B 7/2314; E06B 2001/626; E04B 1/6812; E06B 1/62; E06B 1/702

(57) ABSTRACT

A system, and methods, for preventing fluid infiltration. The fluid infiltration preventing system comprises a horizontal insert foam blocker and a vertical foam blocker. The fluid infiltration preventing system is configured to prevent penetration or infiltration of fluids, such as water, and preferably wind driven water, into an interior region.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/745,698, entitled “SYSTEM AND DEVICES FOR PREVENTING WATER INFILTRATION” and filed on Oct. 15, 2018. The contents of the above referenced application are incorporated herein by reference in its entirety.

### FIELD OF THE INVENTION

The present invention relates to systems and devices that prevent foreign substances from entering a structure; and more particularly, to systems and devices that prevent water from entering a building opening or door; and more particularly, to systems and devices for preventing water traveling at high rates of speed from penetrating or infiltrating a building through a slider window, door slider, or hinged door.

### BACKGROUND OF THE INVENTION

Most buildings structures are designed to house or store something of value, such as human personnel, animals, equipment, valuable artifacts, pieces of art work, or combinations thereof. It is critical that the structure maintain its integrity and prevent unwanted intrusions into the interior. Of particular importance is the ability to prevent water or other debris from infiltrating windows or doors, particularly during extreme weather events.

Devices for preventing water, or other materials, from entering a building are known in the art. U.S. Pat. No. 9,297,134 is described as disclosing a barrier for damming or channeling surface water flow. The barrier is described as being comprised of a non-woven polymer fabric sleeve within which is contained a water absorbent material which, upon contact with sufficient water, swells up to 20 or more times its initial weight. Preferred barriers are described as having a D-shape front lobe and a rear lobe that inhibits overturning of the barrier during use. The water absorbent material is contained within a sheet that is captured by stitching, which is the separator between the front and rear lobes. Barriers made of a dark color, such as black or brown non-woven polypropylene fabric and containing a super absorbent polymer (SAP), only minimally degrade in function when exposed to prolonged sunlight.

U.S. Pat. No. 8,701,350 is described as disclosing a window draft blocker which uses resilient elements held in spaced parallel relationship within a rectangular envelope, and also has at least one impervious sleeve surrounding one of the resilient bodies protecting it from the elements.

U.S. Pat. No. 8,613,171 is described as disclosing a flood barrier system for windows for inhibiting a water breach into a residential or commercial structure. The flood barrier is described to be adapted to fit within a retaining wall cavity using an expansion member to assist a mechanical seal so as to stop water intrusion. The barrier operates with an extruded frame having vertical reveal members and high strength glass. A sealing joint is fitted about the retaining wall and the flood barrier's vertical reveal members for inhibition of flood seepage. The sealing joint, having at least three surfaces forming an open end and a tapered end, is anchored at the bottom wall of the extruded frame member and about the glass flood barrier's vertical reveal members at least 12 inches above the base flood elevation level. Alternatively, a flood panel can be installed in front of the windows for additional protection against water intrusion into the residential or commercial structure.

U.S. Pat. No. 7,762,742 is described as disclosing an apparatus that is designed to hold back flood waters via a series of interconnected long flexible tubular units. Each unit is described to be connected to each other via a sleeve and has a weighted flap portion for additional anchoring. Each unit has its own fill tube and drain plug, and is designed to retain water or other liquid to provide an impervious water barrier when in deployment.

U.S. Pat. No. 6,783,300 is described as disclosing a water structure formed from at least a pair of sleeves from a puncture resistant flexible material joined along common longitudinal surfaces, as by sewing, and include sleeve ends that are formed into closed to maintain closed-off ends of water filled tubes, and include an arrangement, such as an outer sleeve, for maintaining the pair of sleeves in side by side relationship, and/or may include at least one ground sheet for anchoring the water structure.

U.S. Pat. No. 5,291,687 is described as disclosing a window assembly including a sliding window supported within a U-shaped window track which utilizes a compressible foam strip with memory to prevent the accumulation of debris in the window track. After the foam strip has been cut to the length of the window track, it is compressed and pressed into place so as to substantially fill the window track to prevent an accumulation of debris therein, and yet not interfere with movement of the sliding window. In this regard, the foam strip is fitted to the window track so that, as the foam strip expands, its cross-sectional dimensions are such that the window may be supported on a window-supporting rail with little or no contact between the window and the foam strip. After debris, which would otherwise have accumulated within the window track, is collected on the foam strip, the foam strip is removed from the window track. This device appears to have the propose of collection and removal of debris, rather than the prevention of water infiltration.

U.S. Pat. No. 5,001,865 is described as disclosing a molded seal for a door threshold assembly that includes an insert which is T-shaped in cross section, and attached to the top edge of the T is a resiliently compressible tube-like follower. The follower is described to be covered by a durable, water impervious skin, and the insert is positioned within the base of the threshold assembly and the follower is positioned contiguous to a movable threshold member. The tubular portion of the seal will pivot and roll along the movable member as it is raised or lowered, thereby insuring a water tight seal between the movable member and the threshold base.

U.S. Pat. No. 5,010,690 is described as disclosing an elongated extruded door sill member which is supported by a wood base and includes a sloping top wall and a rear wall connected by integral channel portions and a thermal barrier. The channel portions and barrier are described to cooperate to define an upwardly facing cavity, and strips of resilient closed cell foam material are mounted within the channel portions. A vertically adjustable rail member extends longitudinally within the cavity and has side flanges projecting downwardly into the foam strips to form fluid-tight continuous seals. Opposite end portions of the rail member carry pads of the resilient foam material between the flanges for engaging the strips, the channel portions and the thermal barrier to form fluid-tight seals at the ends of the rail member. This device appears to be in constant use, causing wear on the door seals that lead to leaking.

U.S. Pat. No. 5,072,952 is described as disclosing a sealing element, particularly for the sealing of joints, having a foam element which is elastically expandable with delay as a result of impregnation and a substantially air-tight cover. In order to obtain improved tightness of the seal while retaining the advantageous ability of use of such a sealing element, the cover forms an open region within which the foam element is exposed.

U.S. Pat. No. 4,765,094 is described as disclosing a draught excluder which is provided for a door. The draught excluder is described to comprise an elongated member having an outer surface which is at least partially flexible, and an attachment means connected to the elongated member for releasably attaching the elongated member to the bottom of the door. The attachment means comprises a pair of resiliently extensible cords and a pair of rollers, and the elongated member comprises a hollow core located within a sleeve, both of which are permeable to gas, the core containing material for releasing a volatile pesticide.

U.S. Pat. No. 4,691,478 is described as disclosing an infiltration control device which comprises an elongated fabric strip with opposite side margins overlapping at a lap seam to form an elongated tube. The tube is filled with an insulative material. A fastener is provided for releasably securing the tube on the operable element of a door, window or the like.

U.S. Pat. No. 4,463,523 is described as disclosing a weatherstrip assembly comprising an integral extrusion of polymeric material comprising a stiff portion adapted to be adhered on the vertical surface of a door with a flexible strip portion extending below the bottom edge of the door and along a threshold. A first magnetized strip is described to attach on the flexible portion, and a second metal strip is adapted to be adhered to the surface of the threshold so that the strips will be face to face and releasably seal between the door and the threshold when the door is closed.

U.S. Pat. No. 3,968,597 is described as disclosing a novel closure seal embodying the compression of a region of a tubular member adjacent a door mounting edge during closure of the door to pump air into a communicating region of the member disposed along the bottom edge of the door, to expand the same into a seal upon total closure of the door.

U.S. Pat. No. 2,549,284 is described as disclosing a fragmentary front elevation of a door and frame showing a seal made in accordance with the invention applied to the bottom edge of the door.

U.S. Patent Application Publication No. 2013/0042535 is described as disclosing a storm water entry prevention apparatus for a sliding door system which includes a base, a shield, a wedge, and an adapter. The base is described to connect with the bottom side of the existing door frame from the outside, while the shield connects to the base from the top end. The shield is angularly positioned with the existing sliding door so that the water can easily flow away from the base. When the sliding door is opened or closed, the wedge gently pushes the shield away from the sliding door system. In order to accommodate the screen door, the adapter is connected with the base and the existing door frame.

U.S. Patent Application Publication No. 2012/0222361 is described as disclosing a draft stopping device comprised of interior and exterior insulation that allows a user to effectively and efficiently prevent or reduce drafts from entering a home or other structure beneath an exterior door or window. The draft stopping device is described to be relatively inexpensive to manufacture, aesthetically pleasing, and does not require installation hardware that can damage the surface of the exterior door or window for which it is being used.

U.S. Patent Application Publication No. 2011/0283627 is described as disclosing a smoke-barrier device for under-door gaps. A basic barrier is described to comprise a unit of expandable/compressible material covered by one end of a length of fire-resistant and smoke and gas impermeable material, and is sized to completely seal the mandated gap beneath doors in the event of a fire. Another style includes magnetic material on the other end of the length of fire-resistant, moisture and gas impermeable material to further adhere the barrier to a metal door. Intumescent material may be fixed on the central part of the length of fire-resistant, moisture and gas impermeable material. The device is sized to fit commercial and private doors spaces, and is offered in a kit including tape to place about top and side openings of a door, luminescent tape to be placed on a window in the room, and a flashlight of various styles. The fire-resistant material may also be water impermeable. However, the intent is to prevent smoke and fire from passing through the door gaps. The use of water impermeable material does not make the door seal impervious to water.

U.S. Patent Application Publication No. 2007/0151165 is described as disclosing a door sill restrictor for preventing the entry of foreign matter, such as water and airborne particulates, into a building. The door sill restrictor is one selected from a foam member and a sponge member. In one exemplary door assembly, the door sill restrictor is disposed in a space defined by a door and the sill.

U.S. Patent Application Publication No. 2006/0005472 is described as disclosing a seal having a wall or element contoured of a predetermined shape as, for example, in the form of a right circular cylinder, an extension member and a curved sheet member joined to an extension member, with the curved sheet member along the element and curved about the element such that the curved sheet member is spaced from a surface to which the extension member is attached, such as a window sill, so that the curved sheet member is spaced from the surface and the element rolls and is compressed to seal the interface between the sash and the sill when the sash is closed against the sill with minimum abrasion of the seal.

While various devices and methods are known to prevent water infiltration, many devices insufficiently prevent water penetration during times of very severe weather. For example, during a hurricane, associated wind forces are sufficient to propel water at excessive speeds, forcing water into areas that, under normal storm situations, would be prevented from entering inside the building. The present system and devices are designed to prevent water penetration and infiltration even during high wind events.

### SUMMARY OF THE INVENTION

The present invention provides a system, and methods, for preventing fluid, such as water or air, infiltration. The fluid infiltration preventing system is configured to prevent penetration or infiltration of fluids, such as water, and preferably wind driven water, into an interior region. The fluid infiltration preventing system comprises a horizontal component, referred to herein as a horizontal insert foam blocker, and a vertical component, referred to herein as a vertical insertion foam blocker. The systems and devices are designed for preventing water traveling at high rates of speed from penetrating or infiltrating a building through a slider window, door slider, or hinged door. However, the system and devices may also reduce the amount of air infiltration, thereby reducing cooling and heating bills.

Accordingly, it is an objective of the instant invention to provide a system and devices for aiding in preventing fluids or other materials from entering a structure.

It is a further objective of the invention to provide a system and devices for preventing water from entering a building opening or door.

It is a still further objective of the invention to provide a system and devices for preventing water traveling at high rates of speed from penetrating or infiltrating a building through a window.

It is a further objective of the invention to provide a system and devices for preventing water traveling at high rates of speed from penetrating or infiltrating a building through a door slider.

It is yet another objective of the invention to provide a system and devices for preventing water traveling at high rates of speed from penetrating or infiltrating a building through a door.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A illustrates an embodiment of the system for preventing water infiltration secured to a slider window in order to prevent water or other materials from breaching into an interior portion of a structure;

FIG. 1B is a close-up view of the system for preventing water infiltration secured to an additional slider window;

FIG. 1C is a close-up view of the system for preventing water infiltration secured to an additional slider window, shown with the horizontal insert foam blocker;

FIG. 1D is a close-up view of the system for preventing water infiltration secured to an additional slider window, shown with the horizontal insert foam blocker and the vertical insert foam blocker;

FIG. 2 is a perspective view of an embodiment of a horizontal insert foam blocker;

FIG. 3 is an alternative perspective view of the horizontal insert foam blocker;

FIG. 4 is a right-side view of the horizontal insert foam blocker;

FIG. 5 is a left-side view of the horizontal insert foam blocker;

FIG. 6 is a top view of the horizontal insert foam blocker;

FIG. 7 is a bottom view of the horizontal insert foam blocker;

FIG. 8 is a front view of the horizontal insert foam blocker;

FIG. 9 is a back view of the horizontal insert foam blocker;

FIG. 10 is a perspective view of the vertical insert foam blocker;

FIG. 11 is an alternative perspective view of the vertical insert foam blocker;

FIG. 12 is a right-side view of the vertical insert foam blocker;

FIG. 13 is a left-side view of the vertical insert foam blocker;

FIG. 14 is a top view of the vertical insert foam blocker;

FIG. 15 is a bottom view of the vertical insert foam blocker;

FIG. 16 is a front view of the vertical insert foam blocker;

FIG. 17 is a back view of the vertical insert foam blocker;

FIG. 18 illustrates the horizontal insert foam blocker inserted into a frame of a sliding glass door;

FIG. 19 is an illustrative example of a door foam blocker;

FIG. 20 illustrates the door foam blocker attached to a door;

FIG. 21 is an elevation view of an embodiment mechanism for securing the door foam blocker to the door; and

FIG. 22 is a horizontal cross section through a door and foam blocker, illustrating the mechanism for securing the door foam blocker 86 to the door.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

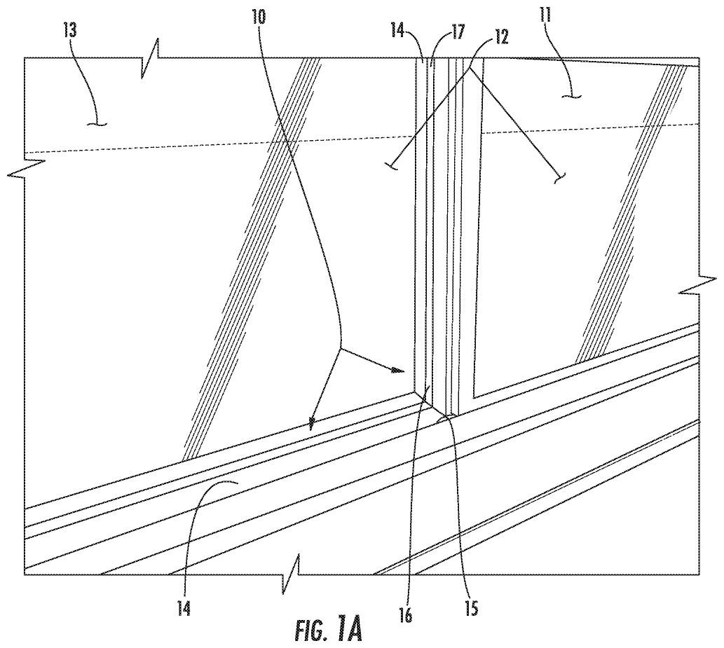

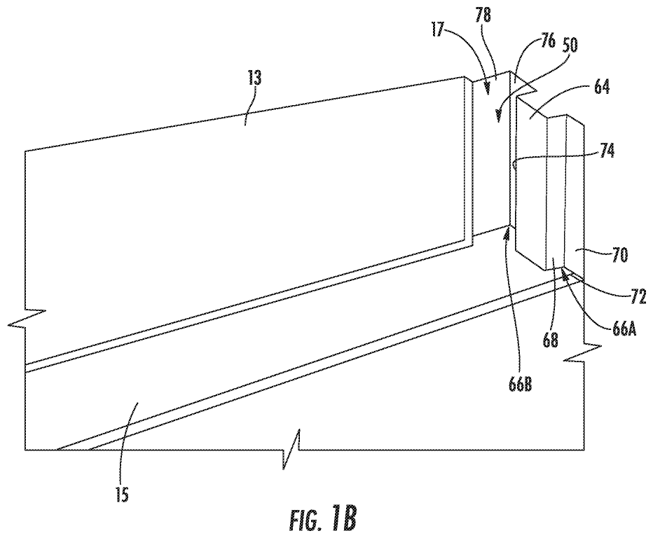

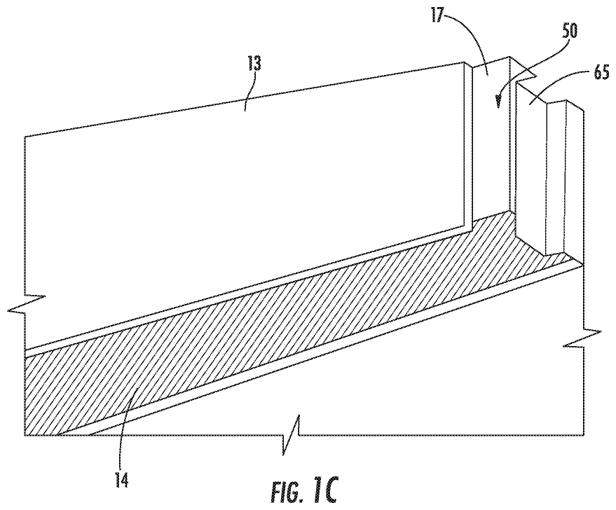

Referring to FIG. 1A, an illustrative example of a system for preventing fluid infiltration, referred to generally as a fluid infiltration preventing system 10, is secured to a slider window 12 associated with a high rise residential structure is shown. The fluid infiltration preventing system 10 is configured to prevent penetration or infiltration of fluids, such as water, and preferably wind driven water, into an interior region. Accordingly, the fluid infiltration preventing system 10 is designed to prevent high pressure fluids, such as wind driven water from a storm having speeds of between 25 and 140 mph, from being driven from an exterior portion of a structure to the interior portion. While the fluid infiltration preventing system 10 is shown placed within a slider window 12, the placement of the fluid infiltration preventing system 10 therein is illustrative only, and can be placed in other areas which require preventing water or other materials from breaching into the interior portion, such as a slider door. FIG. 1A illustrates an inside sliding window 11 and an outside fixed window 13. The inside sliding window 11 slides within sliding window slot 15 when in an open position. In the closed position, as seen in FIG. 1A, storm or wind driven water from the outside can penetrate this area, allowing the storm or wind driven water to an area within the structure housing the inside sliding window 11 and outside fixed window 13. A vertical slot 17, running along an inner edge 19 of the outside fixed window 13 may also provide a source for storm or wind driven water infiltration.

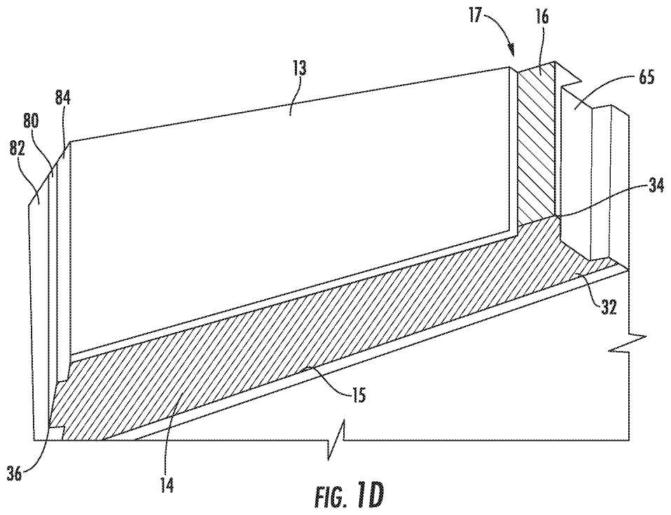

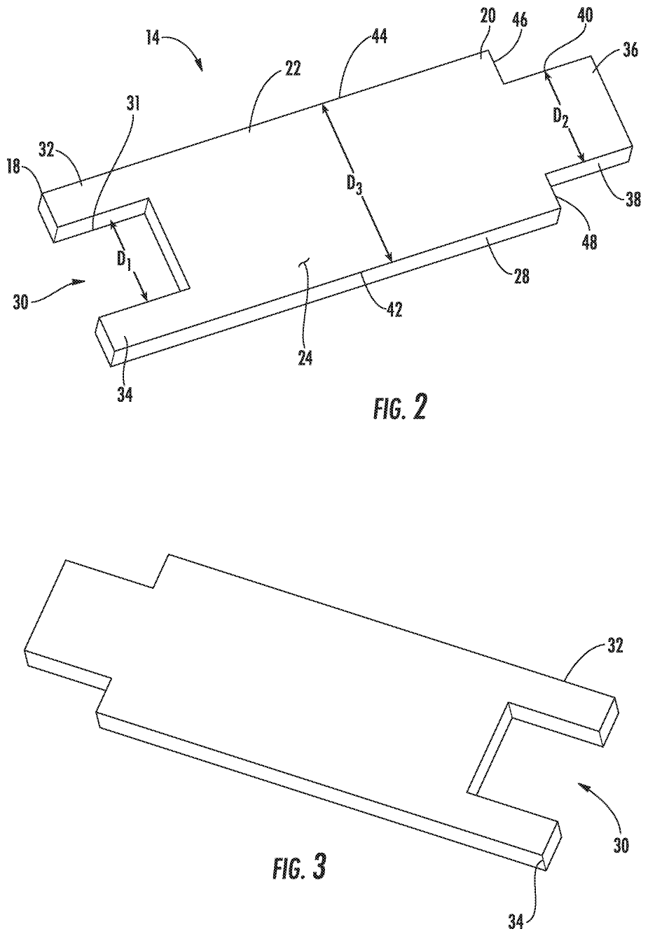

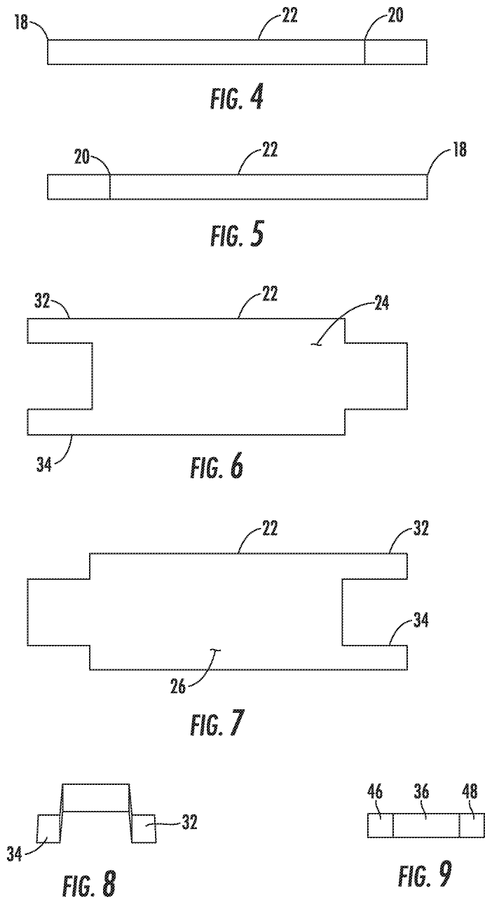

The fluid infiltration preventing system 10 comprises a horizontal component, referred to herein as a horizontal insert foam blocker 14, and a vertical component, referred to herein as a vertical insertion foam blocker 16. Referring to FIGS. 2-9, an illustrative example of the horizontal insert foam blocker 14 is shown. The horizontal insert foam blocker 14 is designed to be inserted into the horizontal sliding window slot 15 that the sliding window 11 occupies when it is in the open position, see FIG. 1A. The horizontal insert foam blocker 14 is inserted into, and occupies the space of the horizontal sliding window slot 15 when the sliding window is in the closed position, thereby preventing or minimizing the risk of outside, storm or wind driven water infiltration. Preferably, the horizontal insert foam blocker 14 is made of a closed cell foam material (made by subjecting a rubber compound to a gas, such as nitrogen, under high pressure). The closed cell foam material may be flexible so that the horizontal insert foam blocker 14 can be bent or deformed to fit a space or area when a force is applied, but assume or maintain its original shape when the force is removed.

The horizontal insert foam blocker 14 comprises a first end 18, an opposing second end 20, and a main body 22 separating the first end 18 and the opposing second end 20. The main body 22 has a first surface 24, a second, opposing surface 26, and a continuous outer perimeter wall or edge 28) The first end 18 contains a U-shaped region 30, formed by a cut out region 31, forming a right arm 32 and a left arm 34. The distance D1 between the right arm 32 and the left arm 34 is preferably a sufficient length to engage and/or cover one or more components of the horizontal sliding window slot 15, and/or other associated window components as described below.

The opposing second end 20 contains a protuberance 36 which extends outwardly, or away from the main body 22. The length D2, measured from edge 38 to opposing edge 40, of the protuberance 36 is preferably less than the length D3 of the main body 22. The length D3 is defined as the distance between edge 42 and opposing edge 44. D1, measured as the distance between the right arm 32 and the left arm 34, is less than D3 and may be equal to, less than, or greater than D2. Shoulders 46 and 48 are formed in the area where the protuberance 36 extends out past the second end 20.

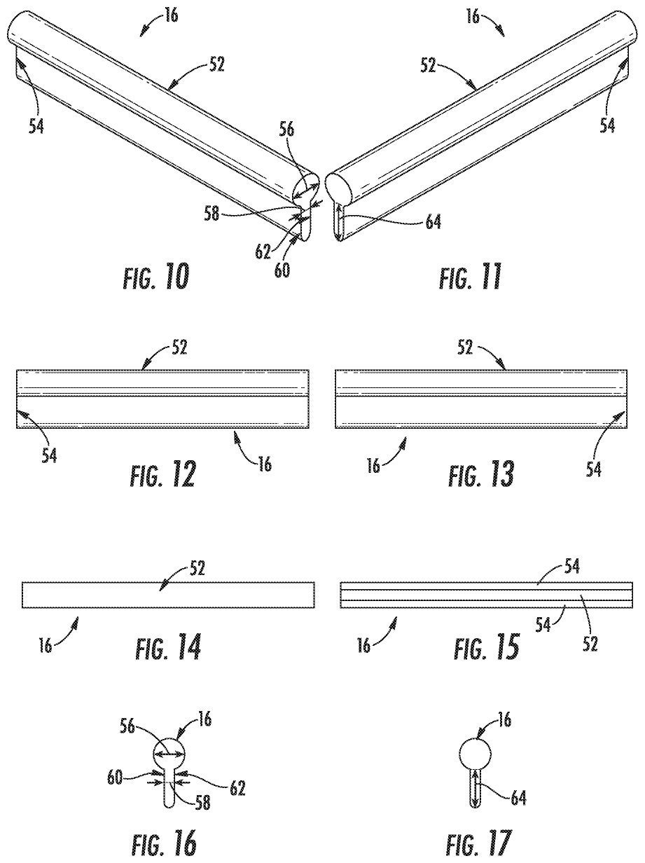

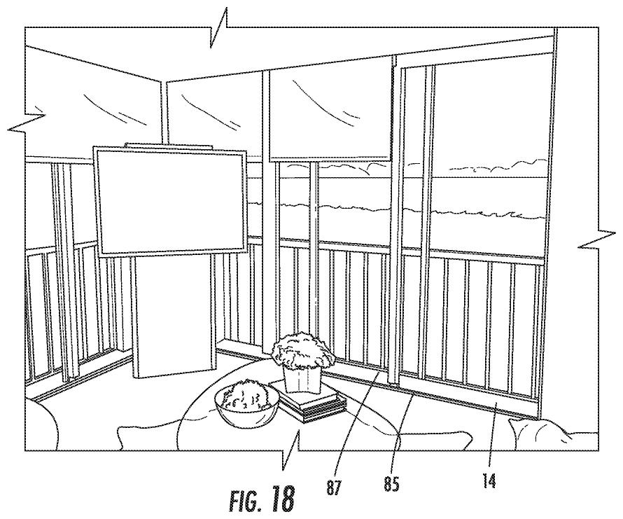

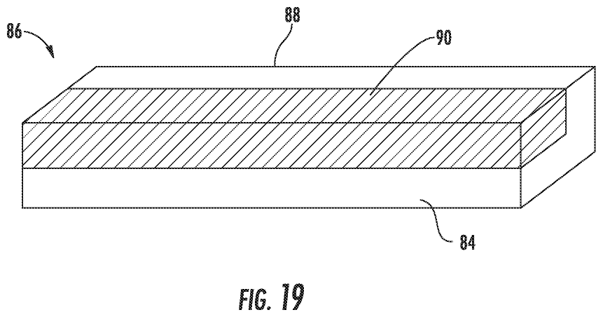

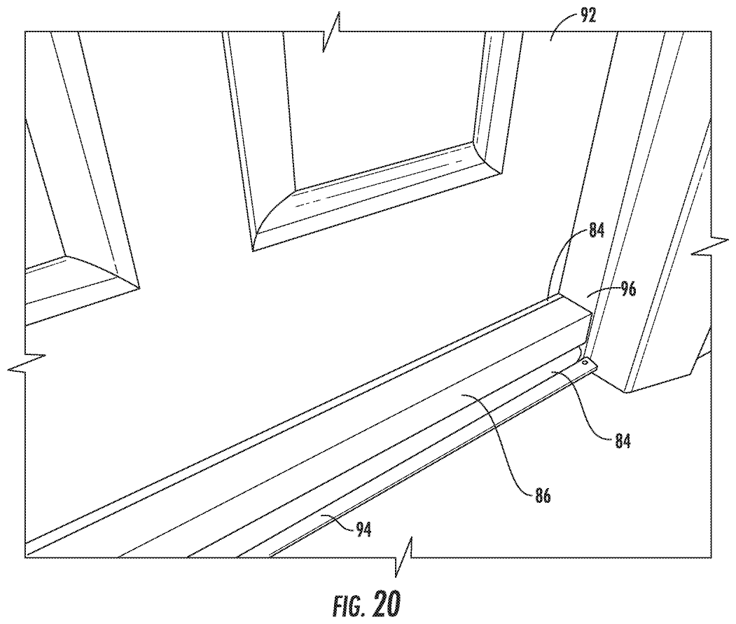

Referring to FIGS. 10-17, an illustrative example of the vertical insertion foam blocker 16 is shown. At least a portion of the vertical insertion foam blocker 16 is configured to fit within the vertical slot 17 and rest within the slider window-outside window vertical gap 50 (see FIG. 1B), thus preventing water from entering the interior of the structure through the slider window-outside window vertical gap 50, see FIG. 1B. Preferably, the vertical insertion foam blocker 16 is made of a closed cell foam material (made by subjecting a rubber compound to a gas, such as nitrogen, under high pressure). The closed cell foam material may be flexible so that the vertical insertion foam blocker 16 is bent or deformed to fit a space or area when a force is applied, but assumes or maintains its original shape when the force is removed. The vertical insertion foam blocker 16 is comprised with an upper portion 52 and a lower portion 54. The upper portion 52 is shown having a generally circular profile. The lower portion 54 extends away from the upper portion 52, and as shown has an elongated, oval-like or tubular profile. The diameter 56 of the upper portion 52 is preferably greater than the length 58 between a first lower portion side 60 and an opposing, second lower portion side 62. While the upper portion 52 is shown having a generally circular profile, other shapes may be used as long as the upper portion 52 seals within the slider window-outside window vertical gap 50. The lower portion 54 has a sufficient length 64 to extend out of the vertical slot 17, thus providing a user a mechanism to remove the vertical insertion foam blocker 16 from the slider window-outside window vertical gap 50 when not needed.

In use, the horizontal insert foam blocker 14 is inserted into horizontal sliding window slot 15 so that arms 32 and 34 of the U-shaped region 30 straddle the window mullion 65. The arms 32 and 34 are sized and shaped to tightly fit space 66A defined by the right side wall 68 of the window mullion 65, wall 70, and sliding window slot side wall 72, and space 66B defined by the window mullion 65, side wall 74 and side walls 76 and 78, see FIGS. 1B and 1C. protuberance 36 is designed to fit within the space defined by the sliding window sill vertical frame 82 and 84. The vertical insertion foam blocker 16 is then placed within the vertical slot 17, see FIGS. 1A and 1D. Upper portion 52 is inserted into slider window-outside window vertical gap 50, with the lower portion 54 extending outwardly and away from the slider window-outside window vertical gap 50.

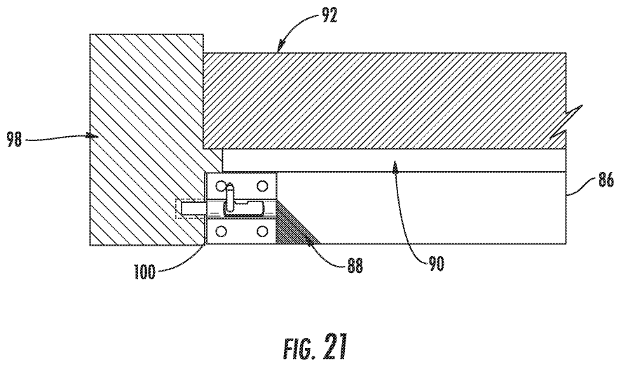

FIG. 18 illustrates the horizontal insert foam blocker 14 inserted into a frame 85 of a sliding glass door 87.

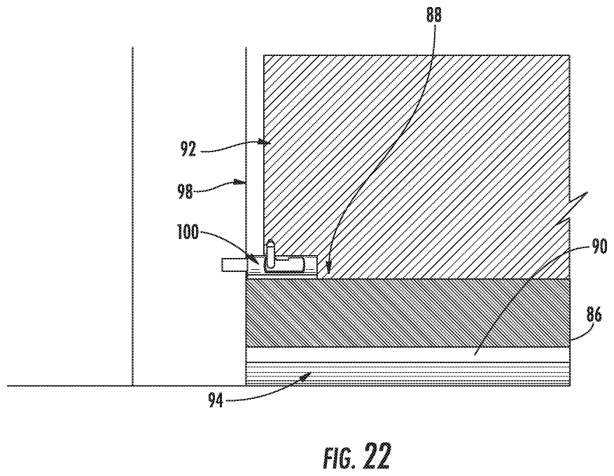

FIGS. 19-20 illustrate a door foam blocker 86. The door foam blocker 86 comprises of a support structure, illustrated as an aluminum angle 88 and a foam 90. The foam 90 may be made of the same material as described for the horizontal insert foam blocker 14 or the vertical insertion foam blocker 16. FIG. 20 illustrates the door foam blocker 86 secured to door 92, forming a barrier with the existing door threshold 94 and existing door vertical mullion 96. FIGS. 21 and 22 show an illustrative mechanism for securing the foam blocker 86 to the door jamb 98 utilizing a slide bolt 100.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fluid infiltration preventing system configured to prevent penetration or infiltration of fluids into an interior region comprising:
a horizontal insert foam blocker configured to be inserted into a horizontal sliding window slot comprising a first end, an opposing second end, and a main body separating said first end and said opposing second end.

2. The fluid infiltration preventing system configured to prevent penetration or infiltration of fluids into an interior region according to claim 1, wherein said first end contains a U-shaped region formed by a cut out region which forms a first arm and a second arm.

3. The fluid infiltration preventing system configured to prevent penetration or infiltration of fluids into an interior region according to claim 2, wherein a distance between said first arm and said second arm is a sufficient length to engage or cover one or more components of a horizontal sliding window slot of a window.

4. The fluid infiltration preventing system configured to prevent penetration or infiltration of fluids into an interior region according to claim 3, wherein said opposing second end contains a protuberance which extends outwardly away from said main body.

5. The fluid infiltration preventing system configured to prevent penetration or infiltration of fluids into an interior region according to claim 4, further including a vertical insertion foam blocker comprising an upper portion and a lower portion.

6. The fluid infiltration preventing system configured to prevent penetration or infiltration of fluids into an interior region according to claim 5, wherein said upper portion comprises a generally circular profile.

7. The fluid infiltration preventing system configured to prevent penetration or infiltration of fluids into an interior region according to claim 5, wherein said lower portion extends away from said upper portion.

8. The fluid infiltration preventing system configured to prevent penetration or infiltration of fluids into an interior region according to claim 1, wherein said interior region is a room separated from the outside by at least a window.

9. The fluid infiltration preventing system configured to prevent penetration or infiltration of fluids into an interior region according to claim 1, wherein said fluid is water.

10. The fluid infiltration preventing system configured to prevent penetration or infiltration of fluids into an interior region according to claim 1, wherein said fluid is wind driven water.

11. The fluid infiltration preventing system configured to prevent penetration or infiltration of fluids into an interior region according to claim 1, wherein said fluid is a high-pressure fluid having speeds of between 25 and 140 mph.

12. A fluid infiltration preventing system configured to prevent high pressure fluids from being driven from an exterior portion of a structure to the interior portion comprising:
a horizontal insert foam blocker configured to be inserted into a horizontal sliding window slot of a sliding window when in an open position, and sized to occupy a space of said horizontal sliding window slot when said sliding window is in the closed position, thereby preventing or minimizing the risk of outside, storm or wind driven water infiltration; and
a vertical insertion foam blocker configured to fit within a vertical slot and rest within a slider window-outside window vertical gap, thus preventing water from entering said interior of said structure through said slider window-outside window vertical gap.

13. The fluid infiltration preventing system configured to prevent high pressure fluids from being driven from an exterior portion of a structure to the interior portion according to claim 12, wherein said horizontal insert foam blocker is made of a closed cell foam material.

14. The fluid infiltration preventing system configured to prevent high pressure fluids from being driven from an exterior portion of a structure to the interior portion according to claim 13, wherein said vertical insertion foam blocker is made of a closed cell foam material.

15. The fluid infiltration preventing system configured to prevent high pressure fluids from being driven from an exterior portion of a structure to the interior portion according to claim 13, wherein said fluid is wind driven water.

16. The fluid infiltration preventing system configured to prevent high pressure fluids from being driven from an exterior portion of a structure to the interior portion according to claim 13, wherein said fluid is a high-pressure fluid having speeds of between 25 and 140 mph
